(19) United States
(12) Patent Application Publication
(10) Pub. No.: US 2026/0361158 A1
(43) Pub. Date: Nov. 12, 2026

(54) SYNCHRONOUS RELUCTANCE MOTOR AND DRIVING APPARATUS FOR RAILROAD VEHICLE

(71) Applicant: Mitsubishi Electric Corporation, Chiyoda-ku, Tokyo (JP)

(72) Inventors: Kenta KANEKO, Tokyo (JP); Yu HAMADA, Tokyo (JP); Naoya JIKE, Tokyo (JP); Moriyuki HAZEYAMA, Tokyo (JP)

(73) Assignee: Mitsubishi Electric Corporation, Chiyoda-ku, Tokyo (JP)

(21) Appl. No.: 19/131,793

(22) PCT Filed: Dec. 7, 2022
(86) PCT No.: PCT/JP2022/045139

§ 371 Date: May 21, 2025

(51) Int. Cl. H02K 1/24; H02K 1/16; H02K 19/02

(52) U.S. Cl. CPC H02K 1/246; H02K 1/16; H02K 19/02; H02K 2213/03

(57) ABSTRACT

A synchronous reluctance motor includes: a stator core having a plurality of slots ; and a rotor core formed in a cylindrical shape on an inner-surface side of the stator core. The rotor core has openings each divided by a center rib into slits. Assume that S denotes the number of slots in the stator core, and 0 denotes a slit interval defined as an angle between midpoints of adjacent slits with respect to a cylindrical center of the rotor core, each of the midpoints being a midpoint of an end portion of the arc-shaped opening of a slit in a circumferential direction, the end portion closest to and extending along an outer peripheral surface of the rotor core. The slit interval θ is represented as: θ=360°/(S×k), where the coefficient k is a positive real number and set as a value falling within a range of 0.6≤k≤0.8.

### FIELD

The present disclosure relates to a synchronous reluctance motor using reluctance torque, and a driving apparatus for a railroad vehicle.

### BACKGROUND

Synchronous reluctance motors are used in railroad vehicles, air conditioners, automobiles, and the like. A synchronous reluctance motor generates magnetic saliency by providing a slit in a rotor core, and is rotated by reluctance torque generated by the magnetic saliency. Meanwhile, the synchronous reluctance motor has a problem in that output torque is inferior to that of a permanent magnet synchronous motor in which a permanent magnet is embedded in a rotor core, and that torque ripple increases due to a steep change in permeance near a slit. In order to solve this problem, Patent Literature 1 below discloses a technique for achieving both high output torque and low torque ripple by setting an interval θ between adjacent slits within a range of 360°/(2S)<θ<360°/(1.5×S), where S denotes the number of slots in a stator core.

In addition, when a slit is provided in the rotor core, the strength of the rotor core decreases. The rotor core needs to have strength sufficient to withstand centrifugal force developed when a rotor rotates. In order to solve this problem, Patent Literature 1 below discloses a technique for improving the strength of resistance to centrifugal force by forming a strengthening member called a rib in a slit.

### CITATION LIST

### Patent Literature

Patent Literature 1: WO 2020/194363 A

### SUMMARY OF INVENTION

### Problem to be Solved by the Invention

However, when the technique of Patent Literature 1 is applied to a synchronous reluctance motor having a small number of poles, the interval θ between adjacent slits decreases. This causes another problem of deterioration in manufacturability. Therefore, for the synchronous reluctance motor having a small number of poles, it is required to establish a technique for further preventing deterioration in manufacturability while achieving both high output torque and low torque ripple.

The present disclosure has been made in view of the above, and an object of the present disclosure is to provide a synchronous reluctance motor capable of further preventing deterioration in manufacturability while achieving both high output torque and low torque ripple.

### Means to Solve the Problem

In order to solve the above-described problems and achieve the object, a synchronous reluctance motor according to the present disclosure includes: a stator core formed in an annular shape, a plurality of slots being formed at regular intervals along an inner peripheral surface of the stator core; a winding housed in each of the slots; and a rotor core formed in a cylindrical shape on an inner-surface side of the stator core. The rotor core has openings. An inner edge and an outer edge of each of the openings are formed by two arcs protruding inward or outward in a radial direction of the stator core. Each of the openings is divided by a center rib into a plurality of slits. Slit groups are formed in layers toward a cylindrical center for each magnetic pole. Each of the slit groups is formed by the plurality of slits. The symbol e denotes a slit interval defined as an angle between midpoints of adjacent slits with respect to the cylindrical center of the rotor core, each of the midpoints being a midpoint of an end portion of the opening of the slit in a circumferential direction, the end portion being closest to an outer periphery of the rotor core, the end portion extending along an outer peripheral surface of the rotor core. In addition, S denotes the number of slots in the stator core. At this time, the slit interval θ is represented by use of a coefficient k as: θ=360°/(S×k), where the coefficient k is a positive real number and set as a value falling within a range of 0.6≤k≤0.8.

### Effects of the Invention

The synchronous reluctance motor according to the present disclosure has the effect of further preventing deterioration in manufacturability while achieving both high output torque and low torque ripple.

### BRIEF DESCRIPTION OF DRAWINGS

FIG. 1 is a diagram illustrating a schematic configuration of a driving apparatus for driving a synchronous reluctance motor according to a first embodiment.

FIG. 2 is a cross-sectional view of the synchronous reluctance motor according to the first embodiment taken along an axial direction of a shaft.

FIG. 3 is a cross-sectional view of the synchronous reluctance motor illustrated in FIG. 2 taken along line A-A of FIG. 2.

FIG. 4 is a cross-sectional view of a portion of a 4-pole 48-slot synchronous reluctance motor illustrated in FIG. 3, the portion corresponding to a single magnetic pole.

FIG. 5 is a cross-sectional view for describing shapes, positions, and layers of slits in a rotor core illustrated in FIG. 4.

FIG. 6 is a cross-sectional view of a portion of a 4-pole 48-slot synchronous reluctance motor different in the number of layers of slit groups from the 4-pole 48-slot synchronous reluctance motor illustrated in FIG. 4, the portion corresponding to a single magnetic pole.

FIG. 7 is a cross-sectional view of a portion of a 4-pole 48-slot synchronous reluctance motor different in the number of layers of slit groups from the 4-pole 48-slot synchronous reluctance motors illustrated in FIGS. 4 and 6, the portion corresponding to a single magnetic pole.

FIG. 8 is a diagram illustrating a result of electromagnetic field analysis performed on the rotor core according to the first embodiment.

FIG. 9 is a diagram showing a first example of a rotor core according to a second embodiment.

FIG. 10 is a diagram showing a second example of the rotor core according to the second embodiment.

FIG. 11 is a diagram illustrating a result of electromagnetic field analysis performed on the rotor core according to the second embodiment.

FIG. 12 is a cross-sectional view of a portion of a 2-pole 24-slot synchronous reluctance motor according to a third embodiment, the portion corresponding to a single magnetic pole.

FIG. 13 is a cross-sectional view for describing shapes, positions, and layers of slits in a rotor core illustrated in FIG. 12.

FIG. 14 is a diagram illustrating a result of electromagnetic field analysis performed on the rotor core according to the third embodiment.

### DESCRIPTION OF EMBODIMENTS

Hereinafter, synchronous reluctance motors and a driving apparatus for a railroad vehicle according to embodiments of the present disclosure will be described in detail with reference to the accompanying drawings. Note that although a synchronous reluctance motor suitable for use in the driving of a railroad vehicle will be described as an example in the following embodiments, this is not intended to exclude application to other uses. Furthermore, in order to give priority to ease of understanding, the reduction scale of each member may be different from actual scale in the accompanying drawings. The reduction scale of each member may also differ between the drawings.

### First Embodiment

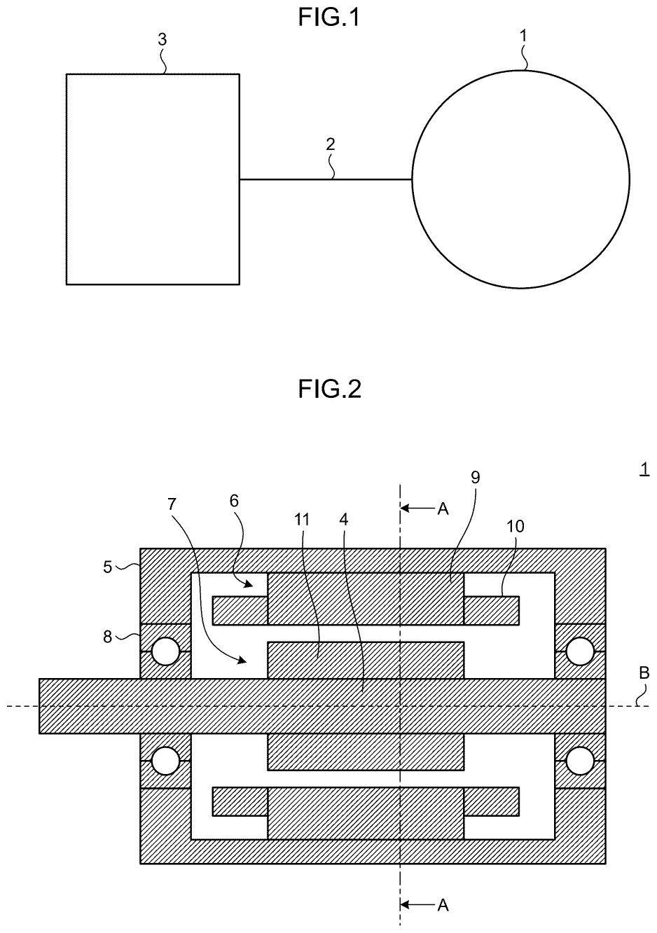

FIG. 1 is a diagram illustrating a schematic configuration of a driving apparatus for driving a synchronous reluctance motor 1 according to a first embodiment. In FIG. 1, the synchronous reluctance motor 1 is connected to a control device 3 via a power supply line 2. The synchronous reluctance motor 1 operates as an electric machine that converts electric energy supplied from the control device 3 into mechanical energy. The driving apparatus illustrated in FIG. 1 can be used as a driving apparatus for a railroad vehicle.

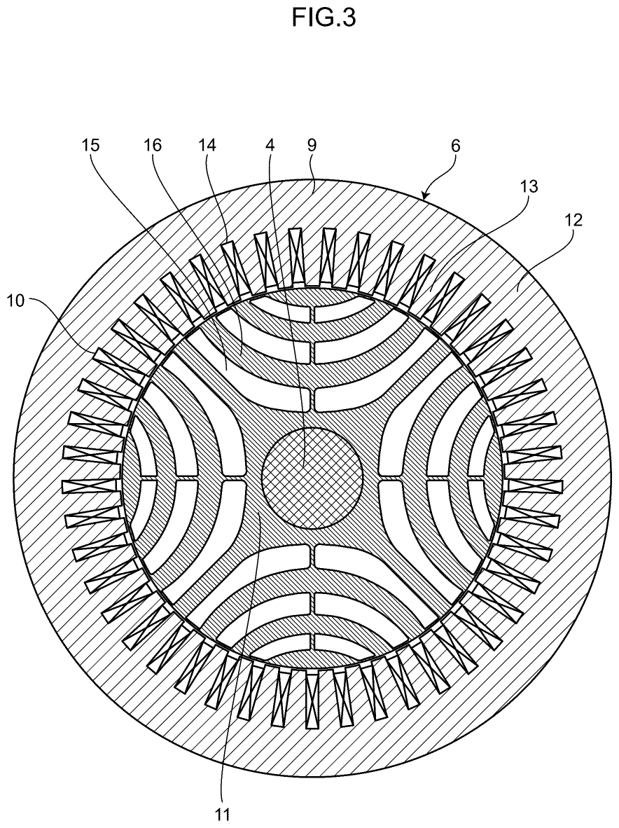

FIG. 2 is a cross-sectional view of the synchronous reluctance motor 1 according to the first embodiment taken along an axial direction of a shaft 4. A broken line B indicated in FIG. 2 corresponds to an axis of the shaft 4. Furthermore, FIG. 3 is a cross-sectional view of the synchronous reluctance motor 1 illustrated in FIG. 2 taken along line A-A of FIG. 2. Note that a frame 5 is not illustrated in FIG. 3.

The synchronous reluctance motor 1 includes a stator 6 in an annular shape and a rotor 7 in a cylindrical shape. The stator 6 and the rotor 7 are inserted into and fixed to the frame 5 by a method such as press fitting or shrink fitting. The stator 6 in an annular shape and the rotor 7 in a cylindrical shape are disposed in such a way as to be relatively rotatable via a magnetic gap 19 provided therebetween, which is a mechanical gap, by means of bearings 8.

A stator core 9 has an annular shape, and is made of an iron core. A winding 10 is applied to the stator core 9 to form the stator 6. A rotor core 11 has a cylindrical shape, and is made of an iron core. The shaft 4 is inserted into the center of the rotor core 11 by a method such as press fitting or shrink fitting. Thus, the shaft 4 and the rotor core 11 are integrated into the rotor 7.

The stator core 9 includes a core back 12 and teeth 13. The core back 12 has an annular shape. The teeth 13 protrude radially inward from the core back 12, and are arranged at regular intervals. A plurality of slots 14 is formed at regular intervals along an inner peripheral surface of the stator core 9 and arranged between the plurality of teeth 13 provided on the inner side in the radial direction of the stator core 9. The winding 10 is housed in the slots 14. In addition, the teeth 13 and the slots 14 are provided at the same angle in a circumferential direction of the annular shape.

In FIG. 3, when P denotes the number of magnetic poles of the rotor core 11, and S denotes the number of slots provided in the stator core 9, P=4 and S=48. That is, FIG. 3 illustrates a cross-sectional structure of the synchronous reluctance motor 1 that is a 4-pole 48-slot synchronous reluctance motor. Note that the number of slots and the number of magnetic poles illustrated in FIG. 3 are examples, and are not limited to the examples of FIG. 3.

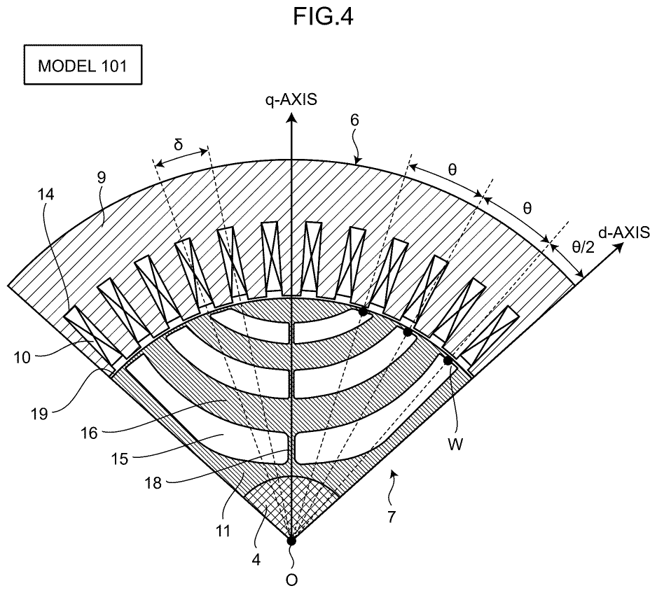

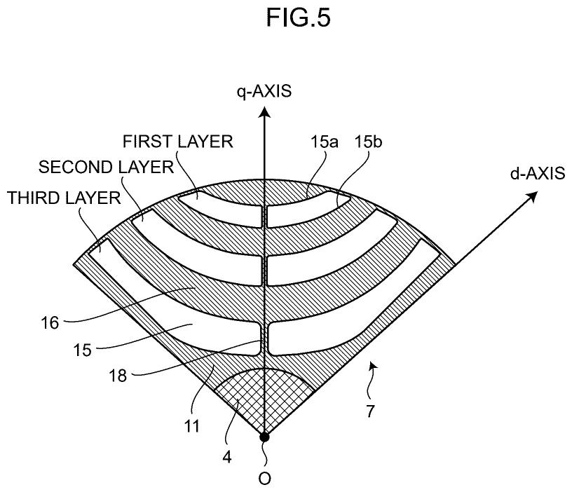

FIG. 4 is a cross-sectional view of a portion of the 4-pole 48-slot synchronous reluctance motor 1 illustrated in FIG. 3, the portion corresponding to a single magnetic pole, and is an enlarged view of a region corresponding to ¼ of the cross section in FIG. 3. FIG. 5 is a cross-sectional view for describing shapes, positions, and layers of slits 15 in the rotor core 11 illustrated in FIG. 4.

First, as illustrated in FIG. 4, the stator 6 of the 4-pole 48-slot synchronous reluctance motor 1 includes 12 slots 14 for each magnetic pole. On the cross sections of the stator core 9 and the rotor core 11 in FIG. 4, a d-axis is defined in a direction of a center line of a magnetic pole, and a q-axis is defined in a direction of a center line between magnetic poles. The direction of the center line of the magnetic pole is a direction in which magnetic flux easily passes, and the direction of the center line between the magnetic poles is a direction in which magnetic flux hardly passes. The d-axis direction may be referred to as a “salient-pole direction”, and the q-axis direction may be referred to as a “non-salient-pole direction”.

The d-axis and the q-axis electrically have a phase difference of 90 degrees. The rotor 7 is rotated by inductance torque generated based on a difference in inductance between the d-axis direction and the q-axis direction. That is, the synchronous reluctance motor 1 generates output torque by using a difference in magnetic resistance in a rotation direction. Therefore, in the synchronous reluctance motor 1, the larger the difference in inductance between the d-axis and the q-axis is, the higher the output torque can be generated.

In FIGS. 4 and 5, a plurality of slits 15 is provided in the rotor core 11 for each magnetic pole of the rotor core 11. The slits 15 are formed by openings protruding inward in a radial direction of the rotor core 11. The plurality of slits 15 forms spaces in the rotor core 11. The slit 15 causes the rotor core 11 to have a structure in which a magnetic path 16 and the slit 15 alternately appear. The magnetic path 16 is a magnetic portion made of magnetic material which is a material of an electromagnetic steel sheet. The slit 15 is a non-magnetic portion formed of air.

As illustrated in FIG. 4, with respect to the d-axis passing through a cylindrical center O of the rotor core 11, a midpoint is defined as a center point of an arc-shaped end portion of an arc-shaped opening of the slit 15 in a circumferential direction, the end portion extending along an outer peripheral surface of the rotor core 11. In FIG. 4, a reference sign “W” is assigned to a circumferential midpoint of the arc-shaped end portion of the slit 15 closest to an outer periphery of the rotor core 11. Furthermore, θ is defined as an angle between a midpoint W of each slit 15 provided in a single magnetic pole and an adjacent midpoint W of an adjacent slit 15 of the each slit 15 with respect to the cylindrical center O of the rotor core 11.

At this time, the slits 15 are provided such that each of the angle θ between the midpoint W of each slit 15 and the midpoint W of the adjacent slit 15 which is adjacent to each slit 15 is equal as a whole. This angle θ is referred to as a “slit interval” in the present specification. An angle formed by the d-axis and a straight line connecting the cylindrical center O of the rotor core 11 and the midpoint W of the slit 15 closest to the d-axis is set to θ/2. Furthermore, in FIG. 4, an angle between adjacent slots in the stator core 9 is referred to as a “slot interval”, and is represented by δ. In the case of the structure of FIG. 4, S=48 and δ=7.5 (=360/48) degrees, where S is the number of slots and δ is the slot interval.

The plurality of slits 15 is distinguished based on the concept of a layer. As illustrated in FIG. 5, a layer closest to the q-axis of the rotor core 11 is referred to as a “first layer”, and other layers are referred to as a “second layer” and a “third layer” in the order from a q-axis side to a d-axis side.

As described above, the rotor core 11 needs to have strength sufficient to withstand centrifugal force developed when the rotor 7 rotates. Therefore, a center rib 18 acting as a strengthening member is formed in each of the slits 15 in the first layer to the third layer. It is possible to form the center rib 18 by leaving a portion corresponding to the center rib 18 when punching a thin steel sheet to form the slit 15.

In the present specification, the plurality of slits 15 in each layer is collectively referred to as a “slit group”. That is, each of the first layer to the third layer has a slit group including the plurality of slits 15 divided by the center rib 18. Furthermore, in each layer, the slits 15 belonging to each slit group are formed in such a way as to be symmetric with respect to the q-axis for each magnetic pole.

An outer edge of an opening of the first layer is formed by an arc 15a protruding inward in the radial direction of the rotor core 11, and an inner edge of the opening of the first layer is formed by an arc 15b protruding inward in the radial direction of the rotor core 11. Inner edges and outer edges of the second layer and the third layer are formed in the same manner. Although not illustrated, centers of the arcs 15a and 15b are both located on the q-axis in the openings of the first layer to the third layer. In each opening, the radius of the arc 15a is shorter than the radius of the arc 15b. In addition, the radii of the arcs 15a and 15b of the first layer are shorter than the radii of the arcs 15a and 15b of the second layer, respectively. The same applies to the relationship between the second layer and the third layer.

Note that, as also illustrated in each of FIGS. 3 to 5, the inner edge of the opening in the slit 15 of the third layer is formed at a certain distance from the d-axis so as not to spread out of a region of the own magnetic pole toward an adjacent magnetic pole side.

As described above, the rotor core 11 is formed in a cylindrical shape on an inner-surface side of the stator core 9, and has openings. Each opening protrudes inward in the radial direction, and has a center located on the q-axis of the magnetic pole. Each opening has an inner edge and an outer edge formed by two arcs with different radii. In addition, the rotor core 11 has a plurality of slits 15 into which the openings are divided by the center ribs 18, and slit groups including the plurality of slits 15 are formed in layers toward the cylindrical center O for each magnetic pole.

Next, a preferable range of the slit interval θ in the first embodiment will be described. First, as described above, the slits 15 are provided such that the slit interval θ between the midpoint W of each slit 15 and the midpoint W of the adjacent slit 15 is equal, for all of the adjacent slits 15. Assume that the slit interval θ is represented by use of the number S of slots and a coefficient k, which is a positive real number, as: θ=360°/(S×k). Here, the coefficient k is set as a value falling within a range of 0.6≤k≤0.8 in the synchronous reluctance motor 1 according to the first embodiment. This setting makes it possible to obtain the synchronous reluctance motor 1 capable of further preventing deterioration in manufacturability while achieving both high output torque and low torque ripple. Hereinafter, the reason for such a setting will be described based on a result of electromagnetic field analysis performed on the rotor core 11 of the first embodiment.

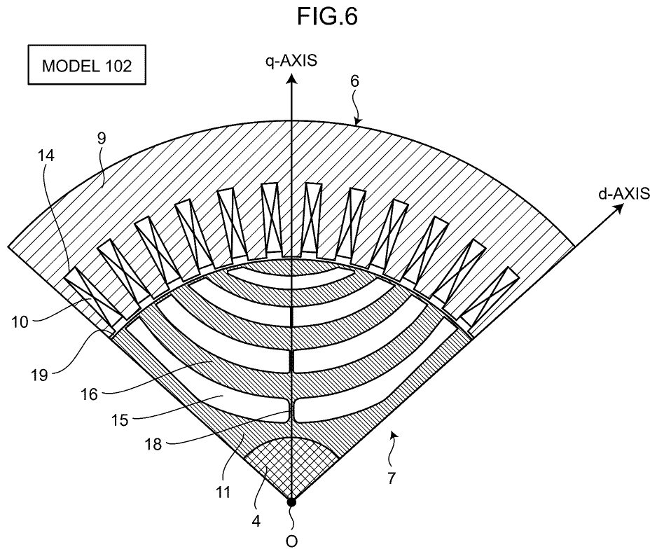

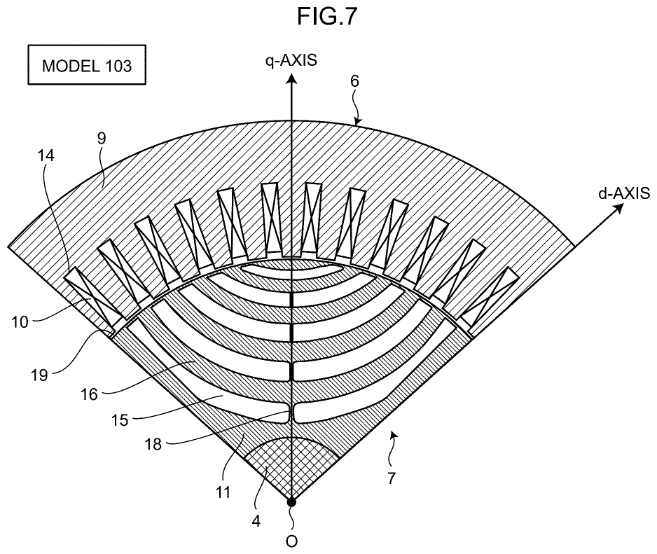

Several types of model are prepared for electromagnetic field analysis. FIG. 6 is a cross-sectional view of a portion of a 4-pole 48-slot synchronous reluctance motor different in the number of layers of slit groups from the 4-pole 48-slot synchronous reluctance motor illustrated in FIG. 4, the portion corresponding to a single magnetic pole. Furthermore, FIG. 7 is a cross-sectional view of a portion of a 4-pole 48-slot synchronous reluctance motor different in the number of layers of slit groups from the 4-pole 48-slot synchronous reluctance motors illustrated in FIGS. 4 and 6, the portion corresponding to a single magnetic pole. Specifically, four layers of slit groups are formed in the rotor core 11 illustrated in FIG. 6, and five layers of slit groups are formed in the rotor core 11 illustrated in FIG. 7. In the present specification, for the sake of convenience, a model having the structure illustrated in FIG. 4 is referred to as a “model 101”, a model having the structure illustrated in FIG. 6 is referred to as a “model 102”, and a model having the structure illustrated in FIG. 7 is referred to as a “model 103”. Note that, in the models 101, 102, and 103, the slit intervals θ are set such that the slit intervals θ between adjacent slits in the plurality of slit groups are all equal.

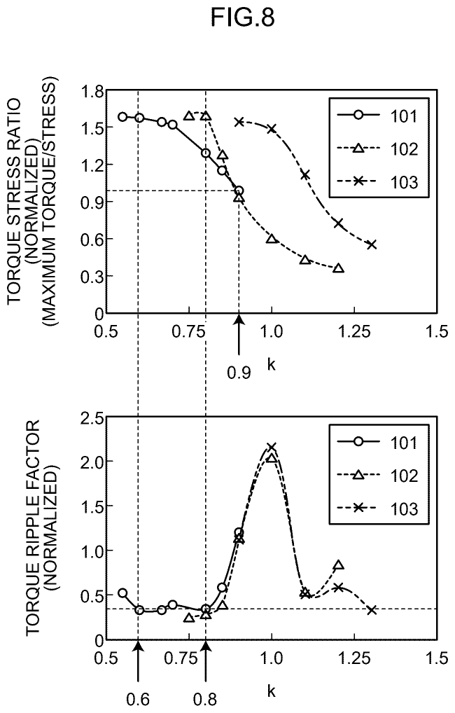

FIG. 8 is a diagram illustrating a result of electromagnetic field analysis performed on the rotor core 11 according to the first embodiment. The upper part of FIG. 8 illustrates how a torque stress ratio changes when the value of the coefficient k is changed. The torque stress ratio is the ratio of maximum torque to stress. The stress here refers to the maximum value of stress to be generated in the rotor core 11. A portion where the stress is maximized corresponds to a portion where the strength of resistance to centrifugal force is minimized. Thus, the stress is introduced as an index representing the strength of resistance to centrifugal force of the rotor core 11. In addition, the lower part of FIG. 8 illustrates how a torque ripple factor (TRF) changes when the value of the coefficient k is changed. The torque ripple factor is the ratio of a difference between a maximum value and a minimum value of output torque to an average value of the output torque, that is, the ratio of a ripple component of the output torque to the average value of the output torque.

Furthermore, in FIG. 8, plots shown by marks “O” and connected by a solid line represent characteristics of the model 101, plots shown by marks “Δ” and connected by a broken line represent characteristics of the model 102, and plots shown by marks “X” and connected by a two-dot chain line represent characteristics of the model 103. The waveforms in the upper part are normalized with a torque stress ratio of 1.0 in the model 101 where the coefficient k is 0.9. In addition, the waveforms of the lower part are normalized for each model with 50% of a torque ripple factor in each model set as 1.0.

FIG. 8 illustrates that when the coefficient k is set to a value within the range of 0.65≤k≤0.8, the torque ripple factor can be reduced while a high torque stress ratio is obtained. The condition that the coefficient k falls within the range of 0.6≤k≤0.8 can be considered a setting value of the coefficient k that makes the characteristic of the torque ripple factor in the model 101 flat and keeps the slit interval θ within a preferable range. Note that data with the coefficient k of 0.8 or less are not shown for the model 103, and only a result with the coefficient k=0.75 and a result with the coefficient k=0.8 are shown for the model 102. In either model, characteristics of the model show a tendency for the torque stress ratio to become flat when the coefficient k is 0.8 or less. Therefore, in either model, when the coefficient k is set to a value within the range of 0.6≤k≤0.8, it is possible to reduce the torque ripple factor while obtaining a high torque stress ratio.

Next, the reason why the above results were obtained will be described. First, when the coefficient k is set to a value within the range of 0.6≤k≤0.8, a change in permeance caused by the stator core 9 and a change in permeance caused by the rotor core 11 do not match, so that the torque ripple factor can be reduced. In addition, the slits 15 provided in the rotor core 11 increase magnetic saliency of the rotor 7, that is, a difference in inductance between the d-axis and the q-axis, so that high output torque can be obtained. This makes it possible to achieve both high output torque and low torque ripple.

In addition, when the coefficient k is reduced, the slit interval θ can be increased. Thus, the electromagnetic steel sheet forming the rotor core 11 can be easily punched, leading to a decrease in manufacturing cost. Therefore, when the coefficient k is set to a value within the range of 0.65≤k≤0.8, it is possible to further prevent deterioration in manufacturability while achieving both high output torque and low torque ripple.

As described above, the synchronous reluctance motor according to the first embodiment includes: a stator core in an annular shape, a plurality of slots being formed and arranged at regular intervals along an inner peripheral surface of the stator core; a winding housed in each of the slots; and a rotor core formed in a cylindrical shape on an inner-surface side of the stator core. The rotor core has openings. An inner edge and an outer edge of each of the openings are formed by two arcs protruding radially inward. Each of the openings is divided by a center rib into a plurality of slits. Slit groups are formed in layers toward the cylindrical center O for each magnetic pole. Each of the slit groups is formed by the plurality of slits. The symbol e denotes a slit interval defined as an angle between midpoints W of adjacent slits with respect to the cylindrical center O of the rotor core, each of the midpoints W referring to a midpoint of an arc-shaped end portion of the arc-shaped opening of a slit in a circumferential direction, the end portion being closest to an outer periphery of the rotor core, the end portion extending along an outer peripheral surface of the rotor core. In addition, S denotes the number of slots in the stator core. At this time, the slit interval θ is represented by use of the coefficient k as: θ=360°/(S×k), where the coefficient k is a positive real number and set as a value falling within the range of 0.6≤k≤0.8. With this configuration, it is possible to reduce the torque ripple factor while obtaining a high torque stress ratio. In addition, when the coefficient k is set to a value within the range of 0.6≤k≤0.8, the slit interval e can be increased, so that deterioration in manufacturability can be prevented. Therefore, according to the synchronous reluctance motor of the first embodiment, it is possible to further prevent deterioration in manufacturability while achieving both high output torque and low torque ripple.

### Second Embodiment

In the first embodiment, regarding the rotor core 11, slit intervals between adjacent slits in the plurality of slit groups are set such that the slit intervals are all equal. Meanwhile, in a second embodiment, a description will be given of the rotor core 11 having a structure in which at least one of slit intervals between adjacent slits in a plurality of slit groups is different from the rest of the slit intervals.

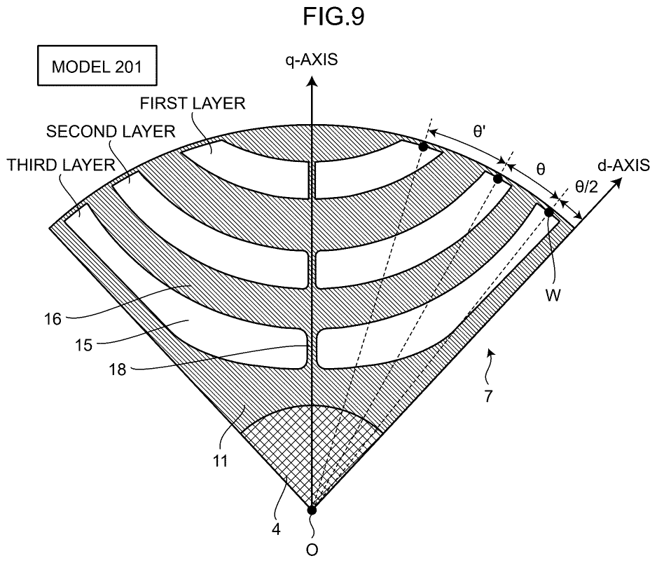

FIG. 9 is a diagram showing a first example of the rotor core 11 according to the second embodiment. In FIG. 9, the same or equivalent constituent elements as those in FIG. 4 are denoted by the same reference numerals or the like. FIG. 9 differs from FIG. 4 in that a slit interval θ′ between the first layer and the second layer closest to the q-axis is larger than the slit interval θ between the second layer and the third layer. As described above, the slit interval θ is represented by use of the number S of slots and the coefficient k as: θ=360°/(S×k). Similarly, the slit interval θ′ is represented by use of the number S of slots and a coefficient k′ as: θ=3600/ (S×k′) . Note that the coefficient k′ is a positive real number similarly to the coefficient k.

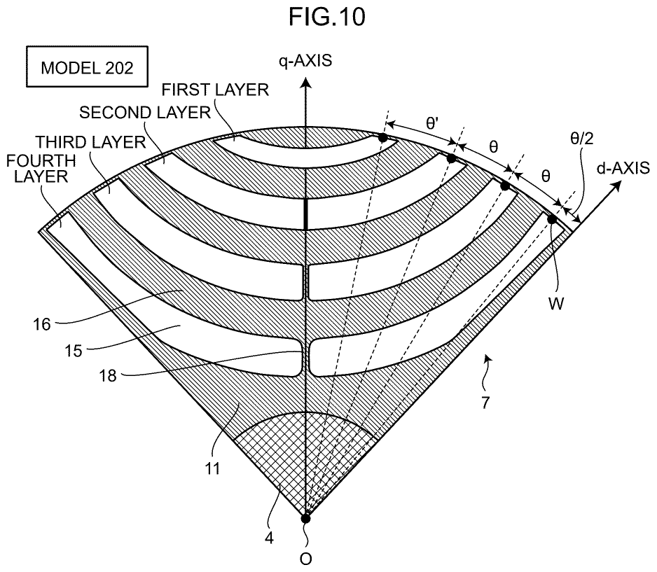

In addition, FIG. 10 is a diagram showing a second example of the rotor core 11 according to the second embodiment. In FIG. 10, the same or equivalent constituent elements as those in FIG. 9 are denoted by the same reference numerals or the like. In FIG. 9, slit groups are formed in three layers from a first layer to a third layer. Meanwhile, in FIG. 10, slit groups are formed in four layers from a first layer to a fourth layer. Specifically, FIG. 10 shows an example in which the slit interval θ′ between the first layer and the second layer closest to the q-axis is larger than the slit interval θ between the second layer and the third layer and the slit interval θ between the third layer and the fourth layer. In the present specification, for the sake of convenience, a model having the structure illustrated in FIG. 9 is referred to as a “model 201”, and a model having the structure illustrated in FIG. 10 is referred to as a “model 202”.

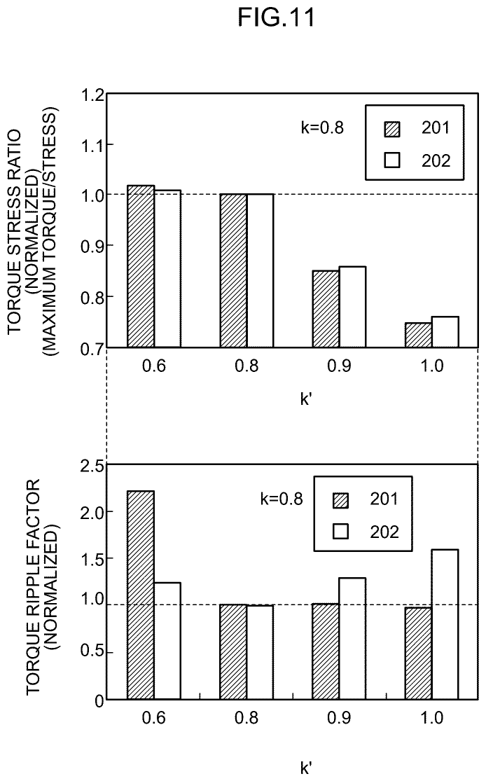

FIG. 11 is a diagram illustrating a result of electromagnetic field analysis performed on the rotor core 11 according to the second embodiment. The upper part of FIG. 11 illustrates how a torque stress ratio changes according to the value of the coefficient k′ changed to 0.6, 0.8, 0.9, and 1.0 when the coefficient k=0.8. In addition, the lower part of FIG. 11 illustrates how a torque ripple factor changes according to the value of the coefficient k′ changed to 0.6, 0.8, 0.9, and 1.0 when the coefficient k=0.8. Note that the case of the coefficient k′=0.6 corresponds to a case where the slit interval θ′ is larger than the slit interval θ as in the examples shown in FIGS. 9 and 10. Furthermore, the case of the coefficient k′=0.8 corresponds to a case where the slit interval θ′ is equal to the slit interval θ as in the examples shown in FIGS. 4, 6, and 7 described in the first embodiment. Moreover, the case where the coefficient k′=0.9 and the case where the coefficient k′=1.0 correspond to a case where the slit interval θ′ is smaller than the slit interval θ.

In FIG. 11, bar graphs to the inside of which hatching is given represent characteristics of the model 201, and bar graphs to the inside of which no hatching is given represent characteristics of the model 202. The bar graphs in the upper part are normalized for each model with a torque stress ratio of 1.0 in each model where the coefficient k′ is 0.8, that is, k=k′=0.8. In addition, the bar graphs of the lower part are also normalized for each model with a torque ripple factor of 1.0 in each model where the coefficient k′ is 0.8, that is, k=k′=0.8.

In the rotor core 11, it is said that a magnetic path in a portion close to the q-axis does not greatly contribute to output torque, but has high sensitivity to Stress. Therefore, it is inferred that when the coefficient k′ is 0.9 or 1.0, the amount of the iron core between the q-axis and the first layer increases, so that stress increases, leading to a decrease in the torque stress ratio. Meanwhile, in the case of the models 201 and 202 in which the coefficient k′ is less than 0.8, it is inferred that there was little change in the torque stress ratio because although the amount of the iron core between the q-axis and the first layer decreased as compared with the models 101 and 102 in which the coefficient k′=0.8, a decrease in stress due to the decrease in the amount of the iron core and a decrease in maximum torque were balanced.

Note that, as illustrated in the lower part of FIG. 11, the torque ripple factor increases in the case of the model 201, but the increase in the torque ripple factor is prevented in the case of the model 202. In the examples of FIGS. 9 and 10, it is considered that the influence of the slit interval θ′ between the first layer and the second layer on the torque ripple factor appears on average in consideration of the balance with the slit interval θ between the other layers. In the case of the model 202, it is inferred that since the number of layers is larger by one than that of the model 201, the influence of the difference in the slit interval θ′ appeared smaller than that in the model 201. Therefore, when, for example, the torque ripple factor does not satisfy specifications, it is possible to take measures of keeping the torque ripple factor within a range defined in the specification by increasing the number of layers of the slit groups. Therefore, it can be said that when the condition of 0.6≤k≤0.8 described in the first embodiment is satisfied, the value of the coefficient k does not need to be the same for all the layers, and at least one of values of the coefficient k between layers may be different from other values of the coefficient k between the layers.

As described above, according to the synchronous reluctance motor of the second embodiment, the rotor core has at least three layers of slit groups, and at least one of slit intervals between adjacent slits in the at least three layers of slit groups is different from the rest of the slit intervals. Even with such a configuration, the effects described in the first embodiment can be obtained.

### Third Embodiment

In the first embodiment, the 4-pole 48-slot synchronous reluctance motor has been described. Meanwhile, in a third embodiment, a description will be given of a synchronous reluctance motor having another structure capable of obtaining the effects described in the first and second embodiments.

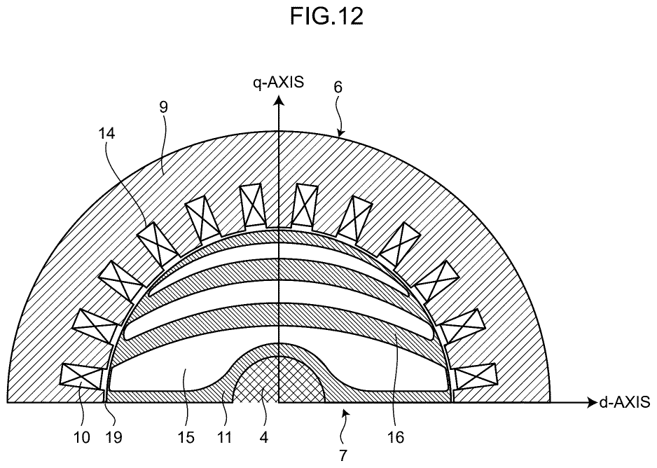

FIG. 12 is a cross-sectional view of a portion of a 2-pole 24-slot synchronous reluctance motor according to a third embodiment, the portion corresponding to a single magnetic pole. As illustrated in FIG. 12, the stator 6 of the 2-pole 24-slot synchronous reluctance motor 1 includes 12 slots 14 for each magnetic pole.

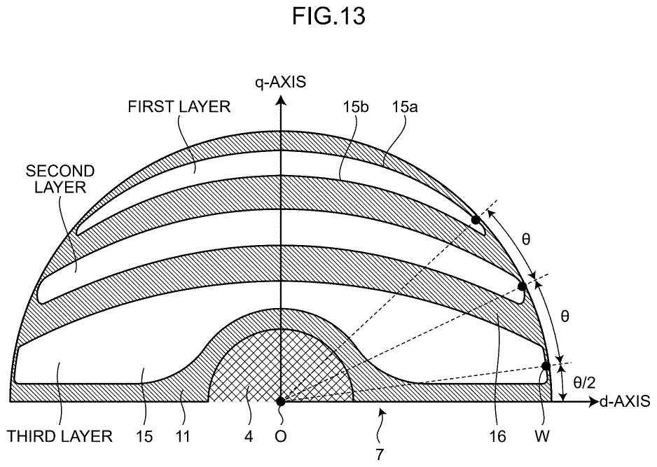

FIG. 13 is a cross-sectional view for describing shapes, positions, and layers of slits 15 in the rotor core 11 illustrated in FIG. 12. On the cross section of the rotor core 11 in FIG. 13, a d-axis is defined in a direction of a center line of a magnetic pole, and a q-axis is defined in a direction of a center line between magnetic poles. The d-axis and the q-axis electrically have a phase difference of 90 degrees. Since the synchronous reluctance motor according to the third embodiment has two poles, an electric angle between the d-axis and the q-axis coincides with a structural mechanical angle which is 90 degrees.

In FIGS. 12 and 13, a plurality of slits 15 is provided in the rotor core 11 for each magnetic pole of the rotor core 11. The slits 15 are formed by openings protruding outward in the radial direction of the rotor core 11. The plurality of slits 15 forms spaces in the rotor core 11. That is, the slit 15 causes the rotor core 11 to have a structure in which the magnetic path 16 and the slit 15 alternately appear. The magnetic path 16 is a magnetic portion made of magnetic material which is a material of an electromagnetic steel sheet. The slit 15 is a non-magnetic portion formed of air.

Furthermore, in FIG. 13, the slits 15 are provided such that the angle θ between the midpoint W of each slit 15 and an adjacent midpoint W of the adjacent slit 15 adjacent to the each slit 15 is equal, similarly to FIG. 4, the midpoints W being along the outer peripheral surface of the rotor core 11 in the opening of the slit 15. Moreover, similarly to FIG. 4, the angle formed by the d-axis and a straight line connecting the cylindrical center O of the rotor core 11 and the midpoint W of the slit 15 closest to the d-axis is set to θ/2.

An outer edge of an opening in the first layer is formed by the arc 15a protruding outward in the radial direction of the rotor core 11, and an inner edge of the opening in the first layer is formed by the arc 15b protruding outward in the radial direction of the rotor core 11. Inner edges and outer edges of the second layer and the third layer are formed in the same manner. Although not illustrated, centers of the arcs 15a and 15b are both located on the q-axis in the openings of the first layer to the third layer. In each opening, the radius of the arc 15a is shorter than the radius of the arc 15b. In addition, the radii of the arcs 15a and 15b of the first layer are shorter than the radii of the arcs 15a and 15b of the second layer, respectively. The same applies to the relationship between the second layer and the third layer.

Note that, as illustrated in FIGS. 12 and 13, the inner edge of the opening in the slit 15 of the third layer is formed at a certain distance from the d-axis so as not to spread out of a region of the own magnetic pole toward an adjacent magnetic pole side. Furthermore, the rotor core 11 illustrated in FIGS. 12 and 13 has no center rib, but may have a center rib similarly to the rotor core 11 according to the first embodiment. That is, the rotor core 11 according to the third embodiment may have a plurality of slits 15 into which openings are divided by center ribs, and slit groups including the plurality of slits 15 may be formed in layers toward the cylindrical center O for each magnetic pole.

As described above, the rotor core 11 according to the third embodiment is formed in a cylindrical shape on an inner-surface side of the stator core 9, and has openings. Each opening protrudes radially outward, and has a center located on the q-axis of the magnetic pole. Each opening has an inner edge and an outer edge formed by two arcs with different radii.

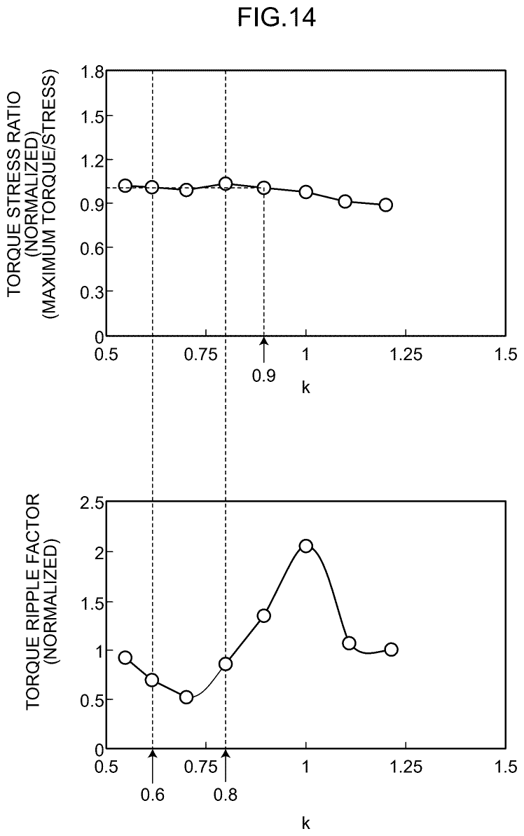

FIG. 14 is a diagram illustrating a result of electromagnetic field analysis performed on the rotor core 11 according to the third embodiment. The upper part of FIG. 14 illustrates how a torque stress ratio changes when the value of the coefficient k is changed. In addition, the lower part of FIG. 14 illustrates how a torque ripple factor changes when the value of the coefficient k is changed.

In FIG. 14, the waveform in the upper part is normalized such that the torque stress ratio is 1.0 when the coefficient k is 0.9, similarly to FIG. 8. Furthermore, the waveform of the lower part is normalized with 50% of the torque ripple factor set as 1.0, similarly to FIG. 8.

As illustrated in FIG. 14, when the coefficient k is within a range of 0.65≤k≤0.8, there is no large change in the torque stress ratio, and the torque stress ratio is stable. In addition, the torque ripple factor has a minimum value within the range of 0.6≤k≤0.8, and is less than 1.0. Therefore, even in the case of the two-pole synchronous reluctance motor, it is possible to obtain the effects described in the first embodiment by setting the value of the coefficient k within the range of 0.65≤k≤0.8.

The configurations set forth in the above embodiments show examples, and it is possible to combine the configurations with another known technique, and is also possible to partially omit or change the configurations without departing from the scope of the present disclosure.

### REFERENCE SIGNS LIST

1 synchronous reluctance motor; 2 power supply line; 3 control device; 4 shaft ; 5 frame; 6 stator; 7 rotor; 8 bearing; 9 stator core; 10 winding; 11 rotor core; 12 core back; 13 teeth; 14 slot; 15 slit; 15a, 15b arc; 18 center rib; 19 magnetic gap.

1. A synchronous reluctance motor comprising:
a stator core formed in an annular shape, a plurality of slots being formed at regular intervals along an inner peripheral surface of the stator core;
a winding housed in each of the slots; and
a rotor core formed in a cylindrical shape on an inner-surface side of the stator core, the rotor core having openings, an inner edge and an outer edge of each of the openings being formed by two arcs protruding inward or outward in a radial direction of the stator core, each of the openings being divided by a center rib into a plurality of slits, slit groups being formed in layers toward a cylindrical center for each magnetic pole, each of the slit groups being formed by the plurality of slits, wherein
when S denotes a number of slots in the stator core, and θ denotes a slit interval defined as an angle between midpoints of adjacent slits with respect to the cylindrical center of the rotor core, each of the midpoints being a midpoint of an end portion of the opening of the slit in a circumferential direction, the end portion being closest to an outer periphery of the rotor core, the end portion extending along an outer peripheral surface of the rotor core,
the slit interval θ is represented by use of a coefficient k as: θ=360°/(S×k), where the coefficient k is a positive real number and
the coefficient k is set as a value falling within a range of 0.6≤k≤0.8.

2. The synchronous reluctance motor according to claim 1, wherein
the rotor core has at least three layers of slit groups, and
at least one of slit intervals between adjacent slits in the at least three layers of slit groups is different from rest of the slit intervals.

3. The synchronous reluctance motor according to claim 1,
wherein
the synchronous reluctance motor is a four-pole synchronous reluctance motor, and
the opening of the slit group is formed by two arcs protruding inward in the radial direction.

4. The synchronous reluctance motor according to claim 1,
wherein
the synchronous reluctance motor is a two-pole synchronous reluctance motor, and
the opening of the slit group is formed by two arcs protruding outward in the radial direction.

5. A driving apparatus for a railroad vehicle, comprising the
synchronous reluctance motor according to claim 1.

6. The synchronous reluctance motor according to claim 2, wherein
the synchronous reluctance motor is a four-pole synchronous reluctance motor, and
the opening of the slit group is formed by two arcs protruding inward in the radial direction.

7. The synchronous reluctance motor according to claim 2, wherein
the synchronous reluctance motor is a two-pole synchronous reluctance motor, and
the opening of the slit group is formed by two arcs protruding outward in the radial direction.

8. A driving apparatus for a railroad vehicle, comprising the synchronous reluctance motor according to claim 2.

9. A driving apparatus for a railroad vehicle, comprising the synchronous reluctance motor according to claim 3.

10. A driving apparatus for a railroad vehicle, comprising the synchronous reluctance motor according to claim 6.

11. A driving apparatus for a railroad vehicle, comprising the synchronous reluctance motor according to claim 4.

12. A driving apparatus for a railroad vehicle, comprising the synchronous reluctance motor according to claim 7.
